(19) United States
(12) Patent Application Publication
(10) Pub. No.: US 2026/0192619 A1
(43) Pub. Date: Jul. 9, 2026

(54) Flexible Joint for Control Arms

(71) Applicant: Greg Foutz, Mesa, AZ (US)

(72) Inventor: Greg Foutz, Mesa, AZ (US)

(21) Appl. No.: 19/082,516

(22) Filed: Mar. 18, 2025

Related U.S. Application Data
(60) Provisional application No. 63/741,793, filed on Jan. 3, 2025.

(51) Int. Cl. B60G 7/00; B60G 7/02

(52) U.S. Cl. CPC B60G 7/005; B60G 7/02; B60G 2204/143; B60G 2204/41; B60G 2204/416; B60G 2206/7102; B60G 2206/72; B60G 2206/73

(57) ABSTRACT

A pivot joint having a center ball with extended shoulders is disclosed. A bushing around the center ball is isolated from direct contact with a control arm by a steel sleeve.

### TECHNICAL FIELD OF THE INVENTION

The present disclosure relates to an improved joint for a billet aluminum control arm.

### BACKGROUND OF THE INVENTION

Billet aluminum is a highly desired material for fabrication of aftermarket vehicle components, particularly in the off-road segment of ATVs, sport utility vehicles and sport trucks. Billet aluminum is very strong and can be highly polished, making it ideal for upgrading visible parts of vehicles, such as radius rods, watts links, tie rods and suspension control arms. The durability to handle the pounding of rugged terrain combined with the beauty of shining components attract enthusiasts who want to trick out their vehicles.

Use of billet aluminum does present some challenges, particularly in applications where components are movably attached to the vehicle frame. Rear suspension control arms, for example, incorporate a pivot joint at the frame. A common upgrade is to replace the original sealed ball joint with a more durable spherical bearing known as a uniball. But a uniball is relatively rigid off its pivot axis. Extreme offroad driving can impart dynamic loads at undesirable angles, and these forces can break even a strong component at the joint.

Inserting a deformable bushing at the joint provides some flexibility and hard rubber bushings are sometimes used. Because the rubber can deteriorate after repeated application of extreme loads, urethane is a preferred, more durable option for bushings. But there is a problem with placing urethane in direct contact with billet aluminum because when urethane rotates in the joint it wears into the aluminum, eventually damaging the part. Thus, it is desirable to apply a urethane bushing that does not directly contact the aluminum.

### SUMMARY OF THE DISCLOSURE

An apparatus for configuring a joint in an arm made of billet aluminum (or other material) with a urethane bushing is disclosed. A stainless-steel tube is pressed into the joint aperture of the arm. A urethane bushing with a stainless-steel center ball is inserted into the tube and the unit is secured to the arm. A grease zerk fitting is inserted through an aperture in the arm and a corresponding aperture in the steel tube.

### BRIEF DESCRIPTION OF DRAWINGS

FIG. 1 is an exploded view of an embodiment of the current invention as used with a suspension control arm.

FIG. 2 is a cross section of an embodiment of the current invention in the suspension control arm of FIG. 1.

FIG. 3 is an exploded view of the components of an embodiment of the invention.

FIG. 4 shows an embodiment of a center ball for use with the invention.

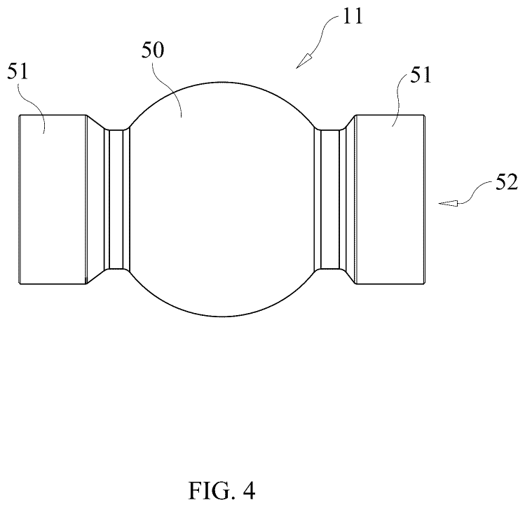

DETAILED DESCRIPTION OF THE INVENTION

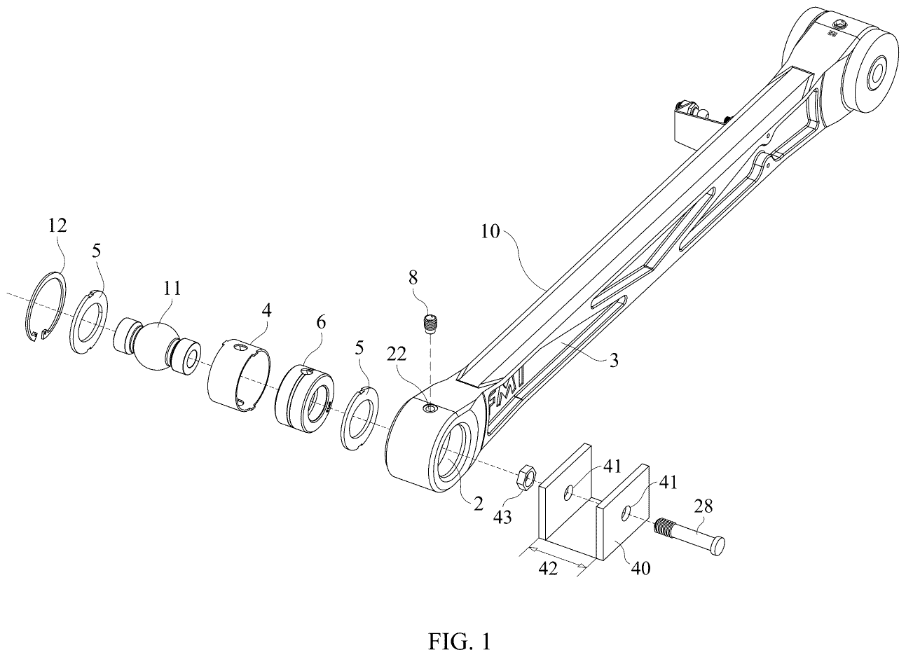

An embodiment of a joint apparatus in accordance with the present invention is shown in FIG. 1. The joint is configured to fit in a billet aluminum aftermarket suspension lower control arm 1 for a 2024 Ford Ranger Raptor (R) truck. The control arm is 29.73 inches long and it includes a 2.26 inch inside diameter joint housing opening at each end. Similar control arms for other vehicles have different dimensions. A joint body tube 4, which may be stainless steel, fits tightly in the arm's joint housing opening 2. A black urethane greasable bushing 6 is pressed inside the body tube 4 and a center ball 11 is pressed inside the bushing 6. Cap plates 5 are fitted at each end of the body tube and a retainer ring 12 holds the assembly to the control arm. Each end of the control arm 1 sits in an OEM connection pocket 40 that is welded to the frame of the vehicle. A securing bolt 28 passes through attachment apertures 41 in pocket 40 and through the center ball 11 and engages securing nut 43.

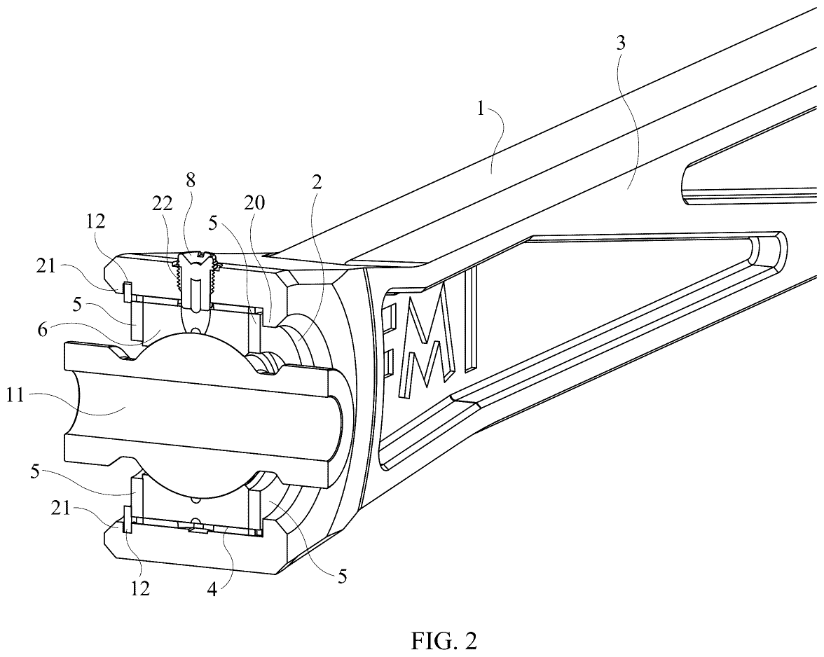

FIG. 2 shows a cross section of a joint assembly in position in the joint housing opening at one end of the control arm. The joint housing opening 2 on the external side 3 of the arm (facing away from the center of the vehicle) includes a circumferential lip 20 that retains the joint assembly. A cap plate 5 abuts the exposed side lip 20 on one side and the body tube 4 on the other. Another cap plate 5 on the internal side 10 of the arm abuts the body tube 4. A ridge 21 around the circumference of internal side 10 of the opening accommodates and contains a retaining ring 12 that abuts the internal side cap plate 5. Depending on the application, the circumferential lip 20 may be on the internal side 10 of the arm with the ridge 21 on the external side 3. For clarity, the terms “ridge side” and “lip side” herein refer to the sides having ridge 21 and lip 20, respectively. An aperture 22 in the top of the arm is configured to hold a grease zerk 8 for servicing of the joint. Alternatively, the zerk aperture could be on the bottom of the arm or on both the top and bottom.

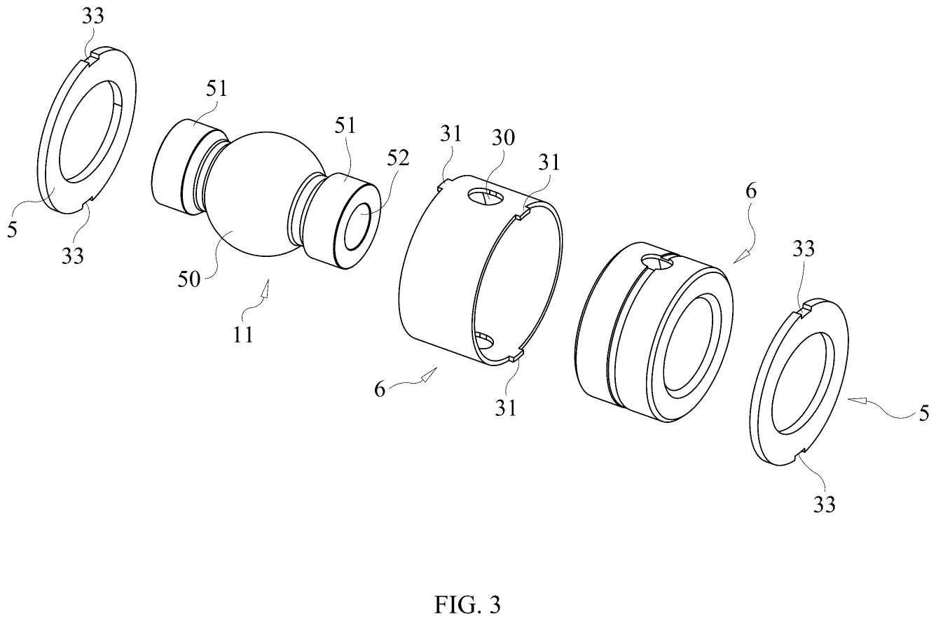

A version of a joint body tube 4 is shown in FIG. 3. The tube is dimensioned for a press fit into the control arm opening 2. In one embodiment for a control arm, the tube is stainless steel with an outside diameter that is 0.002 inches greater than the inside diameter of the opening and a thickness of 0.065 inches to 0.125 inches. Different steel alloys may be used. The tube includes at least one aperture 30 to accommodate a grease zerk and may have another such aperture on the opposite side of its circumference. Optional outward-extending tabs 31 on opposite sides of the tube are positioned to engage slots 33 in end caps 5 to prevent relative rotation of the tube and the end caps. When in place, the tube aperture 30 aligns with the aperture 22 in the arm. A grease zerk 8 inserted through the two openings prevents the tube from rotating in the aluminum arm.

A urethane bushing 6 fits tightly into the joint body tube. In the example embodiment, a 2½ inch outside diameter bushing of 80 durometer hardness is used. Hardness ranging from 30 durometer to 120 durometer may be used, depending on the desired stiffness of the joint. The inside diameter depends on the size of the center ball 11 described below.

A center ball 11, as shown in FIGS. 3 & 4, which is pressed into the bushing 6, comprises a central sphere 50, a pair of extended shoulders 51 and a center bore 52 to carry a securing bolt 28. The spherical diameter of the center ball is determined primarily by the diameter of the control bar opening into which it will be placed. The example embodiment employs a 2⅛ inch diameter ball made of 17-4 stainless steel alloy (otherwise known as SAE Type 630) with 1.17 inch outside-diameter shoulders that are 0.57 inches long. The center bore 52 has a 0.63 inch diameter to accommodate the 16 mm securing bolt 28 that replaces the OEM bolt that previously secured the OEM arm. The shoulders are dimensioned so that the overall length of the center ball closely fits the width of the connection pocket 40. Common OEM securing bolts on many vehicles that are candidates for aftermarket control arms range from 14 mm to 20 mm in diameter, and the bolt diameter on a larger vehicle, such as a ¾ ton truck, is 24 mm. The OEM connection pockets in these vehicles range from 2 inches to 6 inches wide. The inventive design is scalable to any pivot joint where a bushing should be isolated from the rod material.

End caps 5 in the example embodiment are 0.04 inch to 0.25 inch thickness stainless steel rings having an outside diameter that fits the control arm opening 2. Optional circumferential slots 33, the same size as tabs 31 on joint body tube 4 are included. A spring steel retainer ring 12 fits inside the ridge 21 on the ridge side of the control arm opening 2. The total width of the retainer ring 12, the two end caps 5 and the joint body tube is the same as the distance between the ridge 21 and the lip 20 of the host control arm 1.

Assembly and installation of the joint is as follows. An end cap 5 is inserted into control arm opening 2 with slots 33 properly aligned and pressed against circumferential lip 20. The center ball 11 is machine pressed into bushing 6 and the combination is machine pressed into body tube 4. Body tube 4 is then positioned so that its aperture 20 will align with the zerk aperture 22 of the control arm and machine pressed into the control arm. A second end cap 5 is added next to the body tube and the retainer ring 12 is positioned to hold the joint assembly in the control arm. The control arm is then positioned in the host vehicle pocket and attached tightly thereto with the securing bolt 28 and securing nut 43.

The disclosed design has advantages beyond the more durable utilization of a neoprene bushing in a billet aluminum control arm. The grease zerk allows servicing of the joint without removing the ball. Moreover, if the component most subject to deterioration, the bushing, wears out, it can be removed and replaced without discarding the entire joint assembly. With reference to the figures and in particular the example embodiment, incorporating features of the present invention may be used wherever a pivot joint is employed. It will be particularly useful where there is a need to isolate the material of a bushing from direct contact with the material of a control arm or other component that is attached via the joint.

Although certain illustrative embodiments and methods have been disclosed herein, it will be apparent from the foregoing disclosure to those skilled in the art that variations and modifications of such embodiments and methods may be made without departing from the invention. Accordingly, it is intended that the invention should be limited only to the extent required by the appended claims and the rules and principles of applicable law. Additionally, as used herein, references to direction such as “up” or “down” are intended to be exemplary and are not considered as limiting the invention and, unless otherwise specifically defined, the terms “generally,” “substantially,” or “approximately” when used with mathematical concepts or measurements mean within ±10 degrees of angle or within 10 percent of the measurement, whichever is greater.

1. A pivot joint assembly for connecting a first component to a second component, comprising: a center ball with extended shoulders; a bushing that fits tightly around the center ball; and a body tube that fits tightly around the bushing and fits tightly inside and adjacent a joint opening in the first component; wherein the joint assembly is attachable to the second component via a securing bolt passing through a center bore in the center ball.

2. The assembly of claim 1 wherein the first component is a vehicle suspension control arm and the second component is a portion of a vehicle chassis.

3. The joint assembly of claim 2, wherein the control arm is billet aluminum, the bushing is 30 to 120 durometer urethane, and the body tube is stainless steel.

4. The joint assembly of claim 3, further including a cap plate at each end of the body tube.

5. The joint assembly of claim 4, further including a plurality of tabs extending from the steel body tube and wherein the cap plates include circumferential notches configured to engage with the tabs.

6. The joint assembly of claim 5, further including a restrainer for preventing the body tube from rotational movement with respect to the control arm.

7. The joint assembly of claim 6, wherein the restrainer comprises an aperture in the surface of the body tube aligned with a grease zerk aperture in the control arm and a grease zerk inserted through both apertures.

8. A joint assembly for connecting a vehicle suspension control arm, having an opening for the joint assembly, a zerk aperture, and a ridge and a lip on opposite sides of the opening, to a vehicle via an integral connection pocket with attachment apertures, comprising: a center ball with extended shoulders; a urethane bushing that fits tightly around the center ball; and a steel body tube that fits tightly around the bushing and fits tightly inside and adjacent the control arm opening; wherein the assembly is attachable to the connection pocket via a securing bolt passing through a center bore in the center ball and through the apertures in the connection pocket; and wherein the body tube has at least one surface aperture aligned with the zerk aperture.

9. The joint assembly of claim 8, further including a cap plate next to each end of the body tube.

10. The joint assembly of claim 9 wherein the body tube includes outward-extending tabs on each end that engage with circumferential slots included on the cap plates.

11. The joint assembly of claim 10 further including a retainer ring next to one of the end caps wherein the adjacent end cap and retainer ring abut and are constrained by the control arm ridge and the other end cap abuts and is constrained by the control arm lip.

12. The joint assembly of claim 11 wherein the center ball is composed of 17-4 stainless steel alloy (SAE Type 630), the bushing is composed of urethane having a hardness of between 30 and 120 durometer and the cap plates are stainless steel rings between 0.04 and 0.25 inches thick.

13. A billet aluminum suspension control arm having an opening for a joint assembly, a zerk aperture, and a ridge and a lip on opposite sides of the opening, and a joint assembly, the joint assembly comprising: a center ball with extended shoulders; a urethane bushing that fits tightly around the center ball; and a steel body tube that fits tightly around the bushing and fits tightly inside and adjacent the control arm opening; wherein the assembly is attachable to a connection pocket on a vehicle via a securing bolt passing through a center bore in the center ball and through the apertures in the connection pocket; and wherein the body tube has at least one surface aperture aligned with the zerk aperture.

14. The control arm of claim 13, further including a cap plate next to each end of the body tube.

15. The control arm of claim 14, wherein the body tube includes outward-extending tabs on each end that engage with circumferential slots included on the cap plates.

16. The control arm of claim 15 further including a retainer ring next to one of the cap plates wherein the adjacent cap plate and retainer ring abut and are constrained by the control arm ridge and the other cap plate abuts and is constrained by the control arm lip.

17. The joint assembly of claim 2 wherein the center ball is composed of 17-4 stainless steel alloy (SAE Type 630), the bushing is composed of neoprene having a hardness of between 30 and 120 durometer and the cap plates are stainless steel rings between .04 and .25 inches thick.
